(19) United States
(12) Patent Application Publication
(10) Pub. No.: US 2011/0205296 A1
(43) Pub. Date: Aug. 25, 2011

(54) PRINTER WITH A CONTINUOUS JET PRINTING HEAD AND DEVICE FOR CLEANING THE HEAD

(76) Inventors: Thierry Colombat, La Voulte/Rhone (FR); Bruno Barbet, Etoile/Rhone (FR)

(21) Appl. No.: 13/126,166

(22) PCT Filed: Oct. 26, 2009
(86) PCT No.: PCT/EP2009/064075

§ 371 Date: May 4, 2011

Related U.S. Application Data
(60) Provisional application No. 61/116,082, filed on Nov. 19, 2008.

(30) Foreign Application Priority Data
Oct. 28, 2008 (FR) 0857341

(51) Int. Cl. B41J 2/165

(52) U.S. Cl. 347/33

(57) ABSTRACT

The invention relates to a continuous jet printer (1) comprising a printing head (2) and a device (3) for cleaning the operating head upon stopping the printing.

According to the invention, the cleaning device comprises a scraper in a flexible material (300) with a profile mating a profile delimited by the nozzle plate at least at the ejection nozzle(s), by the block for sorting ejected drops from the nozzle(s) and by the recovery end of the gutter.

Displacement means transverse to the direction of the jet(s) as well as a feed and suction of cleaning fluid over the scraper height H or in proximity thereto are also provided, the feed and suction of the cleaning liquid therefore being confined on said scraper height.

### TECHNICAL FIELD

The invention relates to a printer with a continuous jet printing head provided with a device for cleaning the head.

### PRIOR ART

Ink jet printers produce images from the simple line of characters right up to photographic reproduction on substrates of different natures and in various industrial fields.

Printers implementing the continuous ink jet technology comprise one or more printer head(s) with charging electrodes laid out in proximity to the break up point of the jet(s) continuously ejected by ink drop ejection nozzle(s). The charged drops are deflected downstream by deflection electrodes either in a multiple way over a large number of trajectories (in deviated continuous jet technology—with multiple deflection levels) or in a binary way (in binary continuous jet technology—with single deflection level). A recovery gutter laid out underneath the deflection electrodes allows the ink drops non-intended for printing to be collected, two types of layout are possible: in a first layout, the deviated ink drops are recovered by the gutter, whereas non-deviated drops may be used for printing the medium; conversely in the second layout, the non-deviated drops are the ones which are intercepted by the gutter, while it is the deviated drops that are not intercepted by the gutter and therefore printed (the latter is deflected or deviated continuous jet printing technology).

Printers implementing the drop-on-demand technology comprise one or more printing heads, whereby the print heads are equipped with actuators; each said actuator is laid out facing an orifice, which may eject an ink drop directly used for printing the medium.

Regardless of the implemented technology, the quality of the produced images generally tends to deteriorate with increasing operating time, by normal or accidental gradual fouling of the printing head (the optimum conditions for operating the printing head are no longer observed, whence a possible degradation of the printing quality).

To prevent this, ink jet printers are subject to regular care or maintenance in order to eliminate accumulation of dusts, of ink projection. The problem consists of guaranteeing over time the cleanliness of the nozzle plate, through which the ink is ejected, and of the various functional components of the printing head interacting with the ink or the surrounding medium.

The sources of pollutions are numerous:
deposit of particles and dusts conveyed by the outside environment to the printing head, notably by the substrate scrolling in front of the printing head;
accumulation of undesirable ink drops (generally satellite drops), the production of which is inherent to the printing principle;
accumulation of dry extracts, during the operative phase, by spreading of the ink or draining of the ink by capillarity, from the inside of the printing head;
failing ejection of ink, for example during the stopping/starting phase, whether the printing head implements drop-on-demand printing technology or continuous jet technology.

The problem of automated maintenance was contemplated very early in the field of desktop printers implementing the drop-on-demand technology. These printers are equipped with a cleaning station to automatically proceed with maintenance operations in order not to request the user for this operation and to minimize idle times of the printers (i.e. disabled printing periods). Conventionally, cleaning is based on a scraper system (an elastomer) which wipes the outer face of the nozzle plate, and an incoming liquid (solvent, diluent, often simply liquid ink) dissolves the solid particles caught on the nozzle plate and lubricates the sliding surface of the scraper against the nozzle plate. An absorbing material (sponge) stores the waste. This technical solution gives rise to many versions and alternatives patented by the main desktop printer manufacturing corporations, for which the performance of the maintenance function and its automation are primordial. In order to illustrate the concepts developed in the field of automated print-head maintenance for office printing, as examples, mention may be made of U.S. Pat. No. 5,055,856 in the name of Epson, of U.S. Pat. No. 5,907,335 in the name of Hewlett Packard, of U.S. Pat. No. 4,199,767 in the name of IBM, of U.S. Pat. No. 6,688,722 in the name of Canon, of U.S. Pat. No. 6,347,858 in the name of Kodak and finally of U.S. Pat. No. 5,574,485 in the name of Xerox. For these printing heads the nozzle plate is the only functional component which is cleaned. This part is planar, smooth and with a generally sufficiently large surface, for supporting and guiding the movement of a scraper (see for example the solution described in U.S. Pat. No. 6,347,858).

Among the printers used in the field of industrial printing, which implement the continuous jet technology, a family of printers applies so-called hydrodynamic cleaning solutions, i.e. based on the use of a liquid of which the stripping action is in part related to the velocity that it gains upon contacting the parts to be cleaned.

Thus, the spraying of the outer face of the single nozzle 18 plate 19 with a solvent from a jet 22 is known from French Patent FR 2 814 395 of Imaje; in order to discard the ink residues far from the nozzle 18, the projected solvent being removed by evaporation by means of an air flow from the same jet 22. This solution has the drawback of not collecting the produced waste and is limited to strict cleaning of the nozzle 18 plate 19. This drawback is related to the initial idea according to which the question is not to remove the wastes but simply to move them out of the functional area 18 of the nozzle plate.

U.S. Pat. No. 6,575,556 assigned to Videojet finds a remedy to this drawback of the aforementioned patent by placing in proximity to the solvent jet 13, a nozzle 15 for collecting the waste. This nozzle 15 only consists of an orifice laid out in proximity to the ink ejection nozzle (9) and depressurized.

Document US 2005/206673 of Videojet completes the device of the preceding U.S. Pat. No. 6,675,556 with a circular protrusion (crown 32) which confines the cleaning liquid in the surroundings of the ink ejection nozzle 36.

These maintenance solutions are only partial as they are only dedicated to cleaning the outer face of the ink injection nozzle.

U.S. Pat. No. 7,128,410 of Videojet discloses a method for cleaning one of the two deflection electrodes by having a liquid (designated as<<makeup remover>>) streaming along the electrode 24. This liquid is injected at one end of the electrode (on the nozzle plate side) and collected by the gutter 20 for recovering and recycling the non-printed ink.

Document WO 2006/067227 of Imaje is interested with cleaning, by rinsing the gutter 22 by means of a solvent released by the same nozzle as that used for ejecting printing ink. The technical achievements discussed in each of the patents, U.S. Pat. No. 7,128,410 and WO 2006/067227, are therefore limited to the cleaning of a functional component (one of the two deflection electrodes or the gutter for recovering and recycling non-printed ink, respectively).

Document U.S. Pat. No. 6,254,216 of Videojet provides another type of improvement: the printing head only has one aperture 26 in the form of a slot for letting through printed drops, which may be closed by inflating a bladder 42 in order to make the printing head leak-tight and thereby allow purely hydrodynamic cleaning (without any mechanical action) by immersion of all the parts within the sealed printing head.

This cleaning concept by washing a sealed printing head is also utilized by Scitex under the commercially designated “Eyelid” concept. The concept is notably described by U.S. Pat. No. 6,247,781 which describes the most advanced technique thereof (maintenance is a totally automatic operation). The major drawbacks of the method are the lesser efficiency of the cleaning, the use of a liquid with etching properties (and therefore potentially harmful for the operator and/or the environment), and the slowness of the drying of the head, in particular when the liquid is not very volatile (and requires a heating system for promoting drying and evaporation). Additionally, the stirred volumes of liquid are significant, which requires a complex and costly hydraulic circuit, in particular for recycling wastes.

U.S. Pat. No. 6,250,736 of IBM specifically deals with the problem of the efficiency in cleaning of a continuous jet printing head 12 and proposes a combined solution applying the mechanical action of a scraper 26 and the etching action of a hydrodynamic fluid. The cleaning device comprises a scraper 26 fixed in a pan 28 for collecting the wiped and/or detached particles under the pressure of the hydrodynamic fluid. The scraper 26 has a shape so that it may be in simultaneous contact with the lower portion of the nozzle plate 18, and the gutter 14 for recovering non-printed ink drops by self-alignment. A relative mechanical movement (cleaning device 26, 28/printing head 12) produces the mechanical cleaning action on the functional components of the head, which are the nozzle plate 18 and the gutter 14. The proposed structure strongly limits the integration flexibility of the printing head and does not meet the constraints of the field of industrial printing because:
the head 12, which is mobile, will be parked on the cleaning device 26, 28 that extends and necessarily clutters the space underneath the head, which is generally occupied by the medium to be printed; thus, the distance separating the printing head from the medium to be printed is necessarily increased by the bulkiness of the cleaning device or maintenance station 26, 28;
the cleaning liquid and the particles, if the case arises, are directed, under the action of weightiness/gravity towards a drain 40 made in the lower portion of the collecting pan 28, which puts an end to the possibilities of orienting the printing head in different directions, for example upwards;
the cleaning liquid is necessarily expelled under pressure in order to etch the surfaces under the effect of pressure and/or of the flow velocity of the liquid, whence the requirement of having the collecting pan 28 with large dimensions and surrounding the printing head 12 in order not to dirty the environment in the proximity of the latter (for example the medium to be printed, etc.);
the shape of the cavity of the printing head 12 and the slide system 56a, 56b, 58a, 58b between the shuttle 44 supporting the cleaning device 26, 28 and the printing head, by design will interfere with accessing the printing head, which prevents the intervention of an operator if need be.

Further, even if U.S. Pat. No. 6,250,736 does not mention any type of selective deviation system used (deflection electrodes, air flow, or other systems, etc.) nor its implantation in the head, it is difficult to consider the latter insofar that the channel 30 for supplying cleaning liquid is laid out immediately underneath the nozzle plate 18.

Regardless of the contemplated continuous jet technology (with either a “deviated” or binary continuous jet), or of the field of application (industrial or office automation application field), the drawbacks of the cleaning solutions during the maintenance of a printing head according to the prior art are therefore numerous and may thereby be summarized:
the solutions applied for the drop-on-demand technology are neither applicable nor transposable to the continuous jet because they are only limited to the cleaning of the nozzle plate;
an offset of the maintenance station (scraper with collecting pan) from the printing head, poses a problem of overall bulkiness and therefore of integration flexibility and printing availability of the ink jet heads;
a necessary application of gravity for conveying and collecting the cleaning liquid—the cleaning liquid being naturally drained towards a retaining pan (generally emptied automatically)—is an additional drawback to the integration flexibility of the printing head because the orientation of the printing head is imposed (downwards;
a cleaning of the nozzles and surfaces, exclusively by means of a liquid which flows over the surfaces to be cleaned, is inefficient when used with difficult industrial inks that have strong adhesive power (resins and pigments for example);
a cleaning by spraying liquid necessarily under pressure (hydrodynamic) requires a perfect seal, involves a bulky pan for collecting residues in order to contain splashes, and a significantly larger consumption of cleaning liquids than for the devices with a confined cleaning area;
the use of the same gutter for recovering non-printed ink while printing, and for removing wastes during cleaning phases makes their handling complicated because it must not pollute the printing ink: a device for selectively recovering the cleaning/waste liquid (solenoid valves) from the gutter, and for retaining said liquid, raises the cost of the maintenance function;
an increase in the printing distance to printed substrate, resulting from the height of the cleaning device (scraper and collecting pan) localized under the printing head, always has an adverse effect on the marking quality.

The object of the invention is then to propose a new solution for cleaning a continuous jet printing head (either “deviated” or binary), which may be used in the industrial field and which compensates to all or part of drawbacks of the cleaning solutions according to the prior art.

### DISCUSSION OF THE INVENTION

To do this, the subject-matter of the invention is a continuous jet printer comprising a printing head and a device for cleaning the head during operation upon stopping the printing, wherein:
the printing head comprises:
a generator of printing liquid jet(s) comprising a plate provided with at least one nozzle for ejecting the printing liquid along a direction Y;
a sorting block for selectively deviating the liquid released by the nozzle(s) of the generator, laid out adjacent to the nozzle plate while being shifted aside relatively to the ejection direction Y of the nozzle;
a gutter for recovering portions of printing liquid ejected from the nozzle(s) and not intended to be printed; the gutter being laid out adjacent to the sorting block;
the cleaning device comprises:
a scraper in a flexible material having a profile mating a profile delimited by the nozzle plate at least at the ejection nozzle(s), by the sorting block and by the recovery end of the gutter;
means for displacing the flexible scraper, at least along a direction X transverse to the printing liquid ejection direction Y, the displacement of the flexible scraper being such that its deformed profile conforms to and rubs on the matching one delimited by the nozzle plate at least at the nozzle(s), by the sorting block and the recovery end of the gutter;
means for feeding cleaning liquid, on the height of the profile of the flexible scraper along the ejection direction Y simultaneously with its transverse displacement;
means for drawing up liquid resulting from the cleaning by the flexible scraper, on the height of the profile of the flexible scraper along the ejection direction Y simultaneously with its transverse displacement, the suction and feeding means being adapted so as to confine the cleaning liquid between its feed and its suction on the height and in proximity to the profile of the flexible scraper deformed by its transverse displacement.

The sorting system or block according to the invention is a device for selectively deflecting the ink emitted by the nozzle(s) of the drop generator in order to place the printed drops and the non-printed (recycled) ink onto distinct trajectories. In other words, the sorting block is a device which introduces different trajectories for different liquid drops or jet portions. Thus, the sorting block may comprise a device comprising at least one electrode exerting an electrostatic action on one or more jets of liquid. As an example, the sorting system may be a block of electrodes (case of the deviated, continuous, or binary, etc., ink jet technology). The sorting system may also be a block provided with blowing means such as those present in the printing heads according to the air flow technology. The liquid portions recovered by the gutter are drops or jet sections which may either be deflected or not by the sorting block (continuous, binary or “deviated” jet). Depending on whether the gutter recovers the deviated drops or not, the latter has a recovery end shifted relatively to the ejection direction Y of the nozzle or else is located in the axis of the ejection direction Y of the nozzle.

Thus, the invention provides simultaneous cleaning of the three functional surfaces of a continuous jet printing head (the nozzle plate, the sorting block and the recovery end of the gutter for recycling printing liquid), while confining the cleaning liquid on these functional surfaces without it flowing onto another portion of the head.

This maintenance operation may thereby be completely automated while allowing an orientation of the printing head (upwards, downwards as desired depending on the contemplated printing application. Indeed, by providing simultaneous cleaning of all the functional surfaces of the printing head, it is possible to avoid that an operator should have to perform a cleaning of at least one functional surface. By confining the cleaning liquid, it is possible to do without the use of specific means for collecting liquid which flows by gravity such as in U.S. Pat. No. 6,250,736 for example. Finally, by confining the cleaning liquid, it is possible to limit its consumption to just what is required.

The scraper in a flexible material may advantageously comprise an elastomeric part comprising at least two cuts on its thickness, three segments thereby delimited by the cuts each respectively bearing upon the surface delimited by the nozzle plate at least at the ejection nozzle(s), by the sorting block and the recovery end of the gutter.

Optimized mechanical licking of the flexible scraper is thereby obtained by its perfect bearing upon each of the cleaned surfaces without having an adverse effect on the mounting of the flexible scraper. Indeed, it is possible to use several elastomeric parts instead of a single one with cuts, but the mounting is then less easy.

According to an advantageous embodiment:
the scraper in a flexible material is inserted between two rigid flanges to which it is attached by protruding in a plane YZ transverse to the scraping displacement direction X, by thus forming a scraper module;
the cleaning liquid feeding means comprising at least one channel made in the flexible scraper and/or in one of the two attachment flanges in order to bring the cleaning liquid along the height of the flexible scraper;
the cleaning liquid suction means comprising at least one channel made in one of the two attachment flanges in order to draw up the cleaning liquid, containing, if the case arises, particles wiped by the flexible scraper, along the height of the latter, the scraper module being laid out, both during the cleaning operation of the cleaning device and during the printing operation of the head, in order not to protrude underneath the bottom of the recovery gutter, the bottom being defined relatively to a printing liquid ejection direction oriented vertically downwards.

In other words, when the printing head is oriented in order to print vertically downwards, clutter is not increased underneath the printing head unlike certain cleaning devices according to the prior art, such as the one described in U.S. Pat. No. 6,250,376. Thus, marking quality is not undermined by the presence of the cleaning device since the distance between the nozzle plate and the medium to be printed is not increased.

Advantageously, the total width of the scraper module along the transverse displacement direction is such that it may be positioned facing a non-functional area of the sorting block, during the printing operation of the head and upon stopping the cleaning.

In other words, the reduced bulkiness of the scraper module provides integration flexibility of the head. Thus, when the printing head includes a plate provided with a plurality of nozzles (multi-jet printer) and an associated sorting block, the scraper module with a width much smaller than the width of the head, may be positioned in proximity to the jet curtain during the printing operation without having an adverse effect on the global width of the head. Additionally, in this so-called “rest” position for stopping cleaning of the scraper module, all the functional portions of the printing head (nozzle plate, charge and deflection electrodes, gutter) are operational and even accessible: periodic maintenance, repair or another intervention is then possible on these functional portions without it being necessary to disassemble a component of the cleaning device.

According to an advantageous construction embodiment, the flexible scraper is inserted between both flanges in order to assume an ajar position with at least one of the two flanges, and the cleaning liquid feeding and suction channels open out on the face of the ajar flange with the flexible scraper facing the latter, the displacement of the scraper module along the direction X transverse to the printing liquid ejection direction Y bringing the flexible scraper into frictional contact against the nozzle plate, the sorting block and the recovery end of the gutter in its ajar position, thereby allowing the cleaning liquid to be brought through the feeding channel of the ajar flange and the cleaning liquid to be drawn up, containing, if the case arises, particles wiped by the flexible scraper, through the suction channel of the ajar flange.

According to one alternative, only one of the two flanges is laid out protruding relatively to the other of both flanges, the condition ajar being thereby achieved between the elastomeric part and said protruding flange.

According to this construction, it is advantageous to make several cleaning liquid feeding channels on the face of the flange while distributing them uniformly over the height, whereas suction channels are made at the periphery of the liquid feeding channels according to a profile, which is homothetic to the one delimited by the nozzle plate at least at the ejection nozzle(s) by the sorting block and by the recovery end of the gutter.

The channels made in this way thus conform to the profile of the surfaces to be cleaned (sorting block, gutter recovery end, nozzle plate).

According to one alternative, the cleaning liquid feeding means comprise the nozzle plate, at least one channel made in the thickness of the flexible scraper, in order to bring the cleaning liquid onto the height of the flexible scraper via one or more ejected jets of cleaning liquid from the nozzle plate and, the cleaning liquid suction means comprise at least one channel made in the thickness of at least one of the two attachment flanges, in order to draw up the cleaning liquid containing, if the case arises, particles wiped by the flexible scraper over its height.

It is possible to intermittently eject the cleaning liquid jet(s) from the nozzles: the cleaning liquid feeding means then preferably comprise at least one solenoid valve.

The suction means may comprise a suction point underneath the flexible scraper, the bottom being defined relatively to a printing liquid ejection direction oriented vertically downwards.

According to one feature, the suction channel is connected to a depressurized air source, the cleaning liquid feeding pressure being adapted to the air depressurization during the cleaning operation in order to confine the cleaning liquid which contains, if the case arises, particles wiped over the height of the flexible scraper.

The means for displacing the flexible scraper comprise a slide on which a component may slide, the flexible scraper being firmly attached to the sliding component so as to be able to be slid and guided, and the length of the slide is such that the transverse displacement travel of the scraper is larger than the largest width along the translation direction of the flexible scraper, selected from the width of the nozzle plate, of the sorting block and of the gutter. The flexible scraper may thus be positioned at the end of the slide during the printing operation of the head and upon stopping the cleaning.

As regards the cleaning cycles, provision may be made for a cycle only comprising one or more reciprocal movements of the flexible scraper along the transverse direction. A cleaning cycle may also be contemplated, comprising one or more reciprocal movements along the transverse direction and one or more approach and withdrawal movements of the flexible scraper by displacing it away from the nozzle plate, the sorting block and the recovery gutter at the same time.

The displacement means may then be adapted for displacing the scraper in an YZ plane orthogonal to the translational displacement in order to place the scraper away from the nozzle plate, the sorting block and the recovery gutter at the same time.

A particular profile of a printing head to be cleaned according to the invention is such that the sorting block has, facing the jet(s), a planar face or one that is conformed with one or more bevels in the plane orthogonal to the displacement of the flexible scraper (along X).

A type of printer which is aimed by the invention is the one with electrostatic deflection: the sorting block then comprises a device comprising at, least one electrode exerting an electrostatic action on liquid jet(s).

Such an electrostatic device may comprise charge electrodes and deflection electrodes downstream from the charging electrodes.

### SHORT DESCRIPTION OF THE DRAWINGS

Other advantages and features of the invention will become better apparent upon reading the detailed description made with reference to the following figures among which:

FIG. 1 is a schematic sectional view along the height of a printer according to the invention;

FIGS. 2A-2C show a perspective view of a scraper module according to the invention in the assembled configuration and in exploded configurations, respectively;

FIG. 3 is a schematic top view of a first alternative of the scraper module according to the invention upon cleaning the printing head;

FIG. 4 is a schematic top view of a second alternative scraper module according to the invention upon cleaning the printing head;

FIG. 5 is a schematic top view of a third alternative scraper module according to the invention upon cleaning the printing head;

FIG. 6 is a perspective view of a practical embodiment of a printer according to the invention;

FIG. 7 is a schematic perspective view of a printer according to the invention showing the printer head, the scraper module and its displacement means;

FIGS. 8A-8C schematically illustrate different cleaning cycles achieved by different alternative scrapers according to the invention.

### DETAILED DISCUSSION OF PARTICULAR EMBODIMENTS

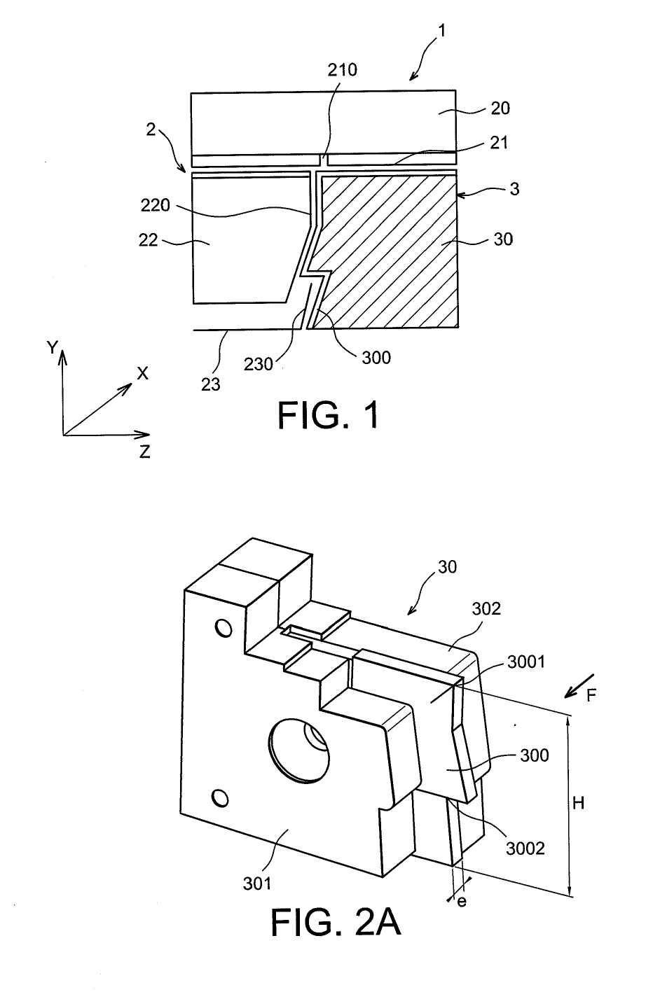

An ink-jet printer 1 provided with a printing head 2, the profile of which may be cleaned by means of the cleaning device according to the invention 3, is illustrated in FIG. 1.

The printing head 2 according to the invention includes a drop generator 20 provided with a nozzle plate 21. In the printing phase, the pressurized ink in the generator 20 flows through a plurality of nozzles 210 aligned along the direction X in order to form a jet curtain. Downstream from the nozzle plate 21, along the ink flow direction (along the Y direction downwards) a sorting block 22 is found, comprising a functional portion 220 with electrodes. During the printing operation, the function of this electrode portion 220 is to place on different trajectories jet portions, an amount of which is collected by the recovery gutter 23 whereas the other one is directed towards the medium to be printed.

The sorting block 22 is laid out adjacent to the nozzle plate 21 while being shifted relatively to the ejection direction Y.

The recovery gutter 23 is laid out adjacent to the sorting block and has a recovery end 230 shifted relatively to the ejection direction Y.

The terms “lower” and “upper”, “below” and “above”, respectively, should be understood with the printing head oriented downwards (flow direction of the jet along Y downwards), i.e. with the generator 20 partly at the base of the block of electrodes 22 according to the invention.

The direction Y is the direction along which ink is ejected from the nozzles 210.

The direction X is the direction along which the nozzles 210 are aligned with each other in order to allow the printing head 1 to cover a certain printed width: the width of the printing head is therefore along this direction X. The translational displacement of the flexible scraper according to the invention is therefore performed along this direction during the cleaning of the head 2 as explained hereafter.

As illustrated in FIG. 1, the sorting block 22 is conformed to a bevel partly delimiting the functional portion 220 with electrodes in the YZ plane.

The cleaning device according to the invention 3 is provided for simultaneously cleaning the profile of the printing head 2 delimited by the nozzle plate 21 at least at the ejection nozzles 210, by the sorting block 22 and by the recovery end 230 of the gutter 23.

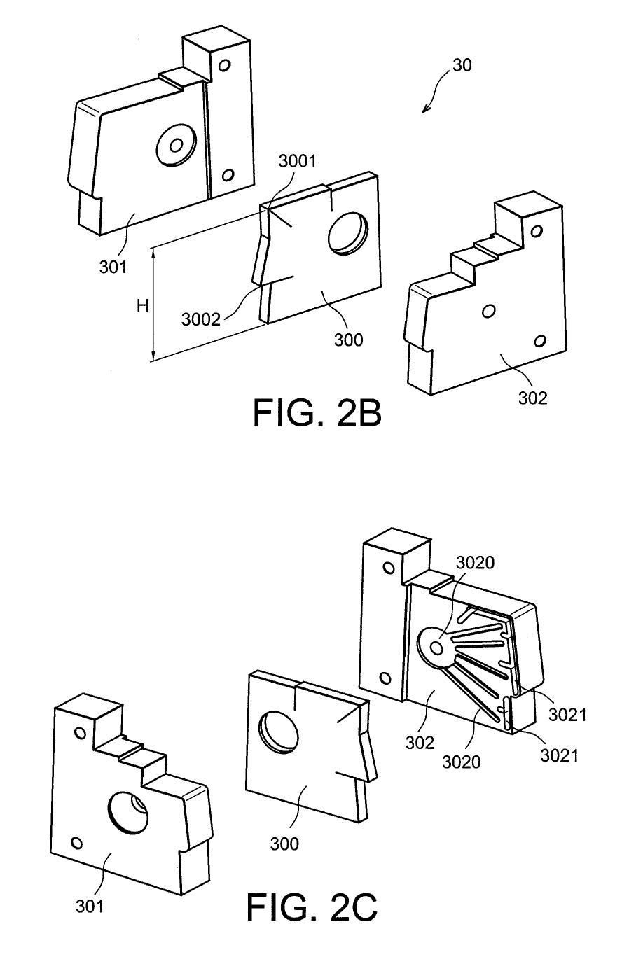

The illustrated cleaning device 3 comprises a scraper module 30. The latter consists of an elastomeric part 300 maintained between two rigid attachment flanges 301, 302, as illustrated in FIGS. 2A-5.

In order to impart satisfactory flexibility to the elastomer, the inventors have found that a thickness e typically of 1-2 mm was suitable.

The nature of the elastomer is selected in order to provide excellent chemical resistance against the ink, the solvent and ink and against cleaning liquids.

The profile of the elastomer 300 mates the one of the head defined above, which one seeks to clean (FIG. 1; FIGS. 2A-2C).

As shown in FIGS. 2A-2C, and in order to inevitably obtain a planar support of the elastomer 300 on each of the three surfaces 21, 220, 230 during cleaning, the elastomer comprises an incision or cut 3001, 3002 at the locations that have angularity or at least at each change in slope. Without these incisions, the elastomer may indeed preferentially bear upon one of the faces 21, 220, 230 and be warped upon contacting the other ones. An alternative may consist of making the elastomer 300 in several portions.

The profile of each of the two rigid flanges 301, 302 also mates the profile of the surfaces 21, 220, 230 to be cleaned, as shown in FIGS. 2A-2C.

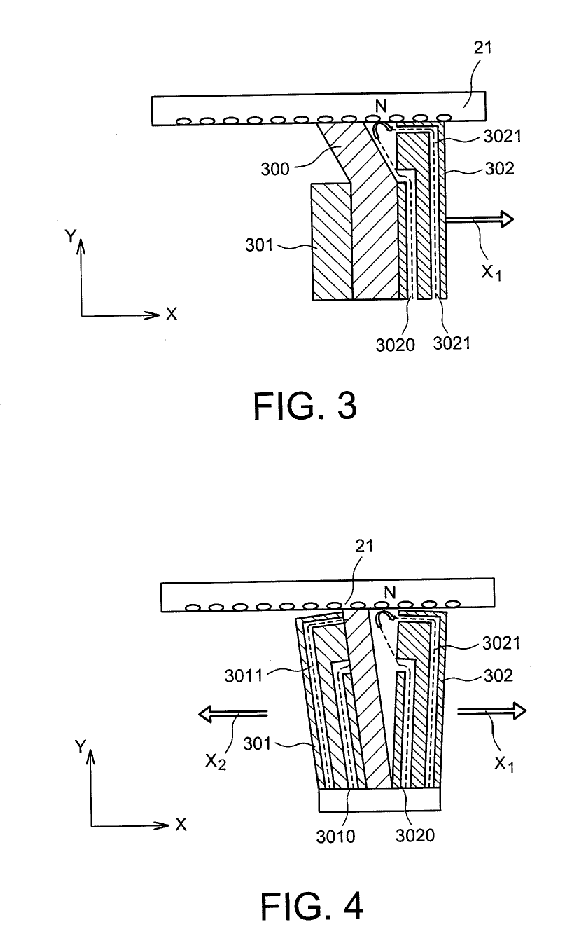

The dimensions of the elastomer 300 and of the flanges 301, 302 as well as their assembly, according to the alternative illustrated in FIGS. 2A-2C and in FIG. 3, are provided so as to have the elastomer 300 protrude relatively to both flanges 301, 302. One of the flanges 302 is itself protruding relatively to the other 301. After assembling these three parts, the elastomer 300 forms approximately a protruding lip that may assume a position ajar relatively to the flange 302 when a force F is applied to it along a transverse direction, which for the cleaning, corresponds to the translational displacement along a given sense of the direction X. The scraper module 30 according to the alternative of FIGS. 2A-2C and in FIG. 3 thereby forms a dissymmetrical module due to the shifting of the flange 301 relatively to the flange 302.

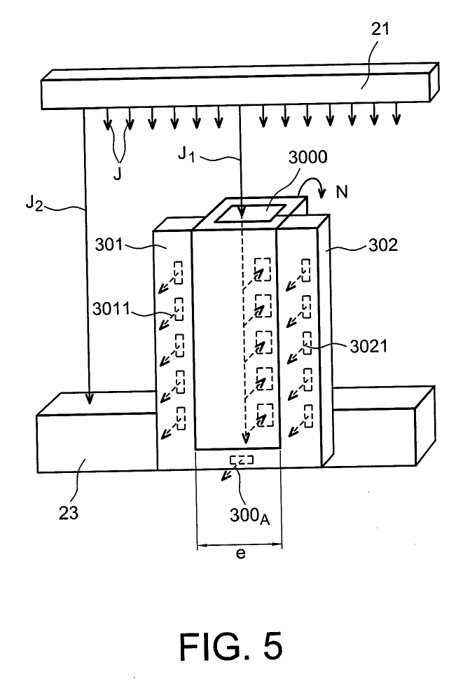

The scraper module according to the alternative illustrated in FIG. 4 comprises two flanges 301, 302, which are not shifted relatively to each other: the scraper module thereby forms a symmetrical module.

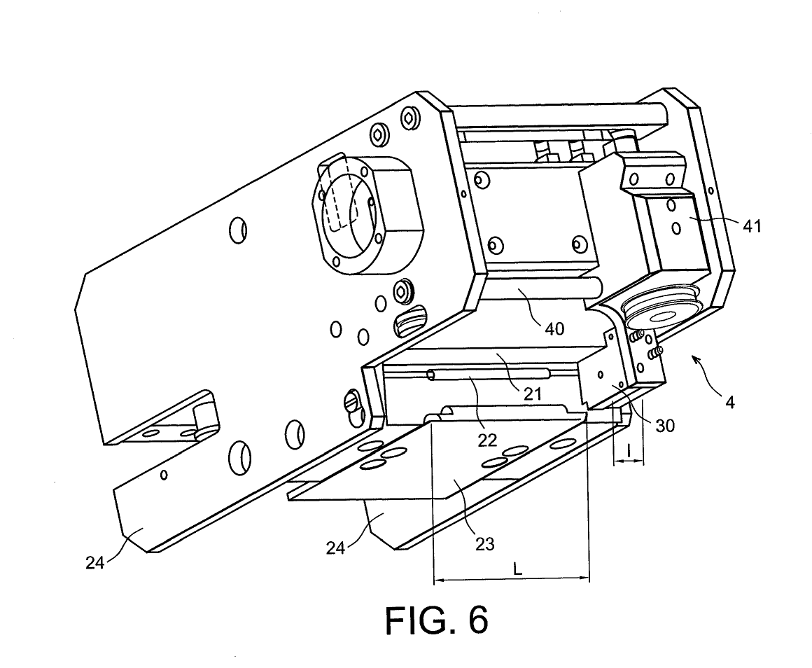

The scraper module according to the alternative in FIG. 5 also forms a symmetrical module but without any mounting with the elastomer 300 being ajar relatively to the flanges 301, 302.

In the different alternatives shown in FIGS. 2A-5, provision is made for a cleaning liquid feed 3000, 3010, 3020 (ink solvent, etching solution, etc.) and suction of the cleaning liquid which, if the case arises, contains the particles wiped by the elastomer 300 by connection with a depressurized air source not shown. The feed and suction are achieved in order to confine the cleaning liquid and the wiped particles by the elastomer 300 over the height H of the flexible scraper in the YZ plane.

In the alternative illustrated in FIGS. 2A-3, the supply and suction over the height of the scraper H are only achieved by a flange 302 and in a determined translation direction X1 relatively to the printing head. The feed is achieved via a fan-shaped network of channels 3020. For suction or in other words recovery of the waste (pollution, cleaning liquid, etc.), the functional contour of the flange 302 is pierced with channels 3021 at the periphery of the fan 3020: any flow onto the printing head is thereby avoided effectively.

In the alternative illustrated in FIG. 4, the supply and suction over the scraper height H are achieved by both flanges 301 and 302 and in both translational directions X1, X2 relatively to the printing head.

In the alternative illustrated in FIG. 5, feed is achieved by the elastomer 300 (in its thickness) and suction is achieved by two rigid elastomeric flanges 301, 302 along both translation directions.

For each of the alternatives of the scraper module 30 as illustrated in FIGS. 2A-5 (symmetrical or dissymmetrical module, with or without the elastomer being ajar relatively to the flanges), the travel of the cleaning liquid from its feed upstream right up to its suction downstream is schematized. In these figures, the travel of the cleaning liquid is symbolized by dotted lines in the feed channels 3000, 3010, 3020, and in the suction channels 3011, 3021 by a bent arrow N that indicates the backflow movement of the liquid which, if the case arises, contains particles wiped by the elastomer 300 after contact with the surfaces to be cleaned.

Thus during a cleaning cycle, in the initial direction X1 of the scraper 30, the lip of the elastomer 300 bears upon the faces of the printing head to be cleaned (the nozzle plate 21 as a sectional view in the XY plane for FIGS. 3 and 4). The elastomeric lip 300 is slightly tilted (laid down under the effect of the displacement) and exerts mechanical pressure on the face 21, 22, 230 to be cleaned. Under the action of the movement of the scraper, the lip of the elastomer exerts a mechanical action on the surfaces being cleaned but also a drying action which removes cleaning liquid. This drying effect is particularly effective for low volatile cleaning liquids.

In the assembly with ajar conditions of FIGS. 3 and 4, the shifting of the flanges is achieved so that the lip 300 of the elastomer assumes a deformed position and rubbing against the surfaces 21, 22 and 230. In this position, the network of channels 3020, 3021 or 3010, 3011 made in the flange 302 (FIG. 3) or the flanges 301, 302 (FIG. 4) is opening out and the cleaning liquid may circulate.

In the whole of the illustrated alternatives, suction is achieved by means of a source of depressurized air connected to the suction channels 3011; 3021. The pressure of the injected liquid and the applied depressurization are thus advantageously adjusted by construction/calibration, in order to prevent any excess of liquid from flowing into the printing head. The cleaning action is achieved by the combined action of wiping by means of the elastomer 300 and of lubrication and transport/evacuation of the wiped particles by means of the liquid. In other words, the liquid does not need to be injected under pressure and/or with significant velocity like in the prior art: the action of the liquid according to the invention is unlike that of a liquid described as hydrodynamic in the prior art (see for example U.S. Pat. No. 6,250,736). The cleaning liquid feed may thereby be handled by a solenoid valve and a calibrated flow restriction (or cone-pointed set screw) in line on the supply circuit (not schematized in the figures).

The alternative of FIG. 5 is a simplification of the scraper module 30: this simplification consists of suppressing the arrival of cleaning liquid at the rigid flange(s) 301, 302 of the scraper 30 and replacing it with a feed of cleaning liquid (for example solvent) from the nozzles 210 of the nozzle plate 21. Thus, when stopping printing and starting cleaning, cleaning liquid jets J are ejected from the nozzles 210 of the plate 21. Among these cleaning liquid jets, during the translation of the scraper, certain jets J1 are guided in the thickness of the elastomer 300 via channels 3000 made in the thickness e in order to be redistributed over the height H and towards the surfaces to be cleaned. The other cleaning jets J2 outside the wiping area are then selected by the recovery gutter 23. The suction channels 3021 according to this alternative are also made in the thickness of the flanges 301, 302. In order to limit consumption of liquid, ejection of the jets by the nozzles 210 is activated by means of a solenoid valve intermittently.

In FIG. 5, it may be seen that provision may be made for a suction point 300A of the liquid slightly below the flexible scraper 30: the drawn liquid anyhow remains confined in proximity to the deformed scraper profile 30 during its translation.

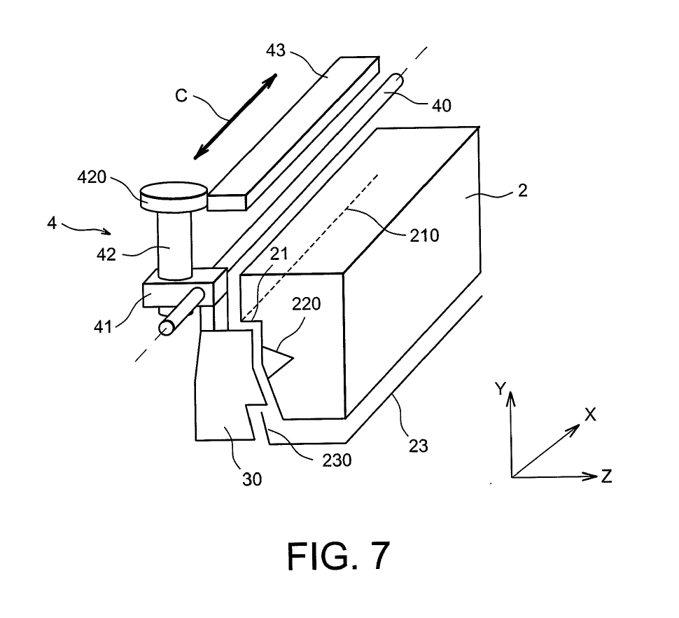

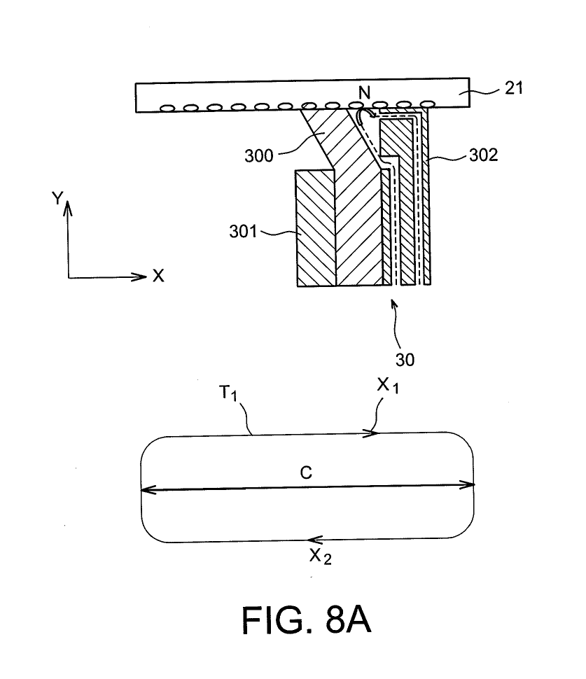

FIG. 7 illustrates an embodiment of the displacement means 4 of the flexible scraper according to the invention 30. These displacement means 4 comprise a slide 40 on which a component 41 is capable of sliding translationally parallel to the nozzles 210 along the axis X. The scraper 30 is firmly attached to this component 41. An axis 42 is rotatably mounted in the component 41. The displacement travel C of the component 41 and therefore of the flexible scraper 30 is larger than the largest width of the alignment of the nozzles 210, the functional area 220 and the gutter 23. Thus, upon a printing operation and during the stopping of the cleaning, the flexible scraper 30 may be positioned at one end (FIG. 6). In order to make sure that the scraper (and more generally the scraper module integrating the means for feeding and sucking the cleaning liquid) is positioned in this “rest” position area or “parking” area, implanting a mechanical abutment on the end or carrying out a readout of the encoder of the motor providing the displacement of the component 41 may be contemplated. In FIG. 6, it is seen that the scraper 30 is in the rest position, i.e. during the printing operation and when cleaning is stopped: here the largest length is formed by the recovery gutter 23. The rest position is therefore outside this length L. It may be also seen that the scraper module 30 does not protrude underneath the gutter 23 and the plates 24 for attaching the printing head.

The means for displacing the flexible scraper further comprise an eccentric 420 orthogonally attached to the axis 42. By means of this eccentric 420, combined displacement of the scraper may be obtained i.e.:
a longitudinal translational movement along the X direction so that the scraper 30 may sweep through the jet curtain;
a forward/backward movement which causes the scraper 30 to either rub the faces to be cleaned, or not. Indeed, at the end of travel, rotation of the eccentric (of elliptical shape) 420 on itself is provided depending on its position along the X direction.

Thus, on the displacement travel C, the eccentric 420 is bearing upon its guiding rail 43 along its half-axis of larger length. At the ends, outside the travel C, the eccentric 420 may undergo a rotation of 90°, in order to have its short half-axis of smaller length bear against the rail 43. Such a change in support (changeover from the long half-axis to the short half-axis) for the eccentric 420 on the rail 43 has the effect of removing the scraper 30 from its position for rubbing the surfaces to be cleaned by rotation around the axis 42.

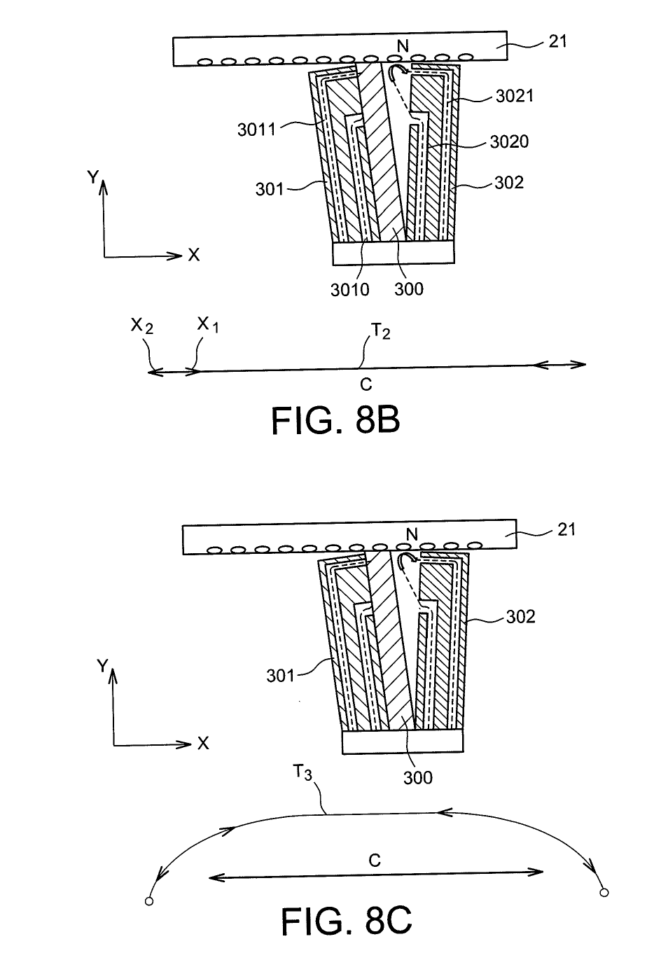

When the scraper module 30 is dissymmetrical with the feed and suction of the liquid through a same attachment flange 302, the displacement means are adapted so as to give said scraper a trajectory T1 according to FIG. 8A. This trajectory has the appearance of a closed loop shaped as a racecourse. It may be achieved by the means described earlier in FIG. 7: the rotation of the eccentric 420 then only occurs at an end of translational travel. This displacement trajectory T1 is indeed required for a dissymmetrical scraper module owing to the following reasons:
in a given direction X1, the elastomer 300 has to be somewhat laid down (i.e. putting the lip of the elastomer so as to exert pressure against the surfaces to be cleaned), and the cleaning action (wiping with injection of cleaning liquid and suction as explained earlier) has to be exerted;
in the reverse direction X2, the scraper 30 should slightly come free from the printing head so as to return to its starting point. This clearing movement avoids accumulation of pollutions on the elastomer 300 on the side of the flange 301 setback and not comprising feed and suction channels. This clearing movement is performed in the embodiment of FIG. 7 by rotating the eccentric by 90°, and displacing the scraper 30 in the YZ plane.

For a symmetrical scraper module 30, a trajectory T2 according to FIG. 8B may advantageously be provided. Thus, the trajectory T2 is a reciprocal trajectory. According to the advanced direction X1, the tilted lip 300 bearing against the surfaces cleans them with the liquid brought and sucked by the flange 302. In this X1 direction, the lip 300 bears against the other flange 301 and then blocks the cleaning liquid feed 3010 and suction 3011 channels. In the reverse direction X2, the process is symmetrical.

In the case of a symmetrical scraper module 30, displacement means may also be provided in order to cause it to follow a trajectory T3 according to FIG. 8C, i.e. with a reciprocal movement combined with withdrawal and approach at the end of travel C.

Depending on the needs, a cleaning cycle may comprise one or more movements along the trajectories T1, T2 or T3.

With respect to cleaning devices presently known in ink-jet printers according to the state of the art, the cleaning device according to the invention, which has just been described, provides the following advantages:
all the functional portions of the continuous jet printing head are cleaned, maintenance may be totally automated: the nozzle plate 21, the sorting block 22 and the recovery gutter 23 are rubbed, washed and wiped with the flexible scraper 300 and with the cleaning liquid;
the scraper module 30 has reduced side bulkiness (width 1), which provides flexibility for integration into a printing head. Thus, the scraper module is a mechanical assembly with a small thickness as compared with the thickness of the printing head and it may be positioned in the rest mode, during printing operation, in proximity to the jet curtain at the end of the translational travel, without having an adverse effect on the overall width of the printing head. All the functional portions of the printing head thus remain operational and accessible and therefore do not interfere with periodic maintenance operations or possible repair operations to be performed on the head;
the active cleaning area is very localized on the height or in proximity to the flexible scraper profile, which limits consumption of the cleaning liquid;
the cleaning liquid is confined into a restricted volume: there is therefore no need to provide liquid flow systems by gravity. The printing head may thus be oriented on demand;
the elastomer which rubs against the printing head provides an absolutely necessary mechanical action for removing pollutions that may adhere to the surfaces to be cleaned. The profile of the elastomer adapted to the geometry of the head allows surfaces, which are not in the same plane, to be cleaned simultaneously.

According to the alternative wherein the cleaning liquid is brought by the ejection nozzles, the consumed liquid may be less (possible intermittent activation by solenoid valve(s));
the trajectories followed by the flexible scraper may easily be adapted either depending on the symmetry of the scraper module, or not: any accumulation of waste at the end of the translational travel of the scraper may thus be suppressed as desired;
the scraper module 30 has a reduced height (along the Y direction) without any harmful clutter below the printing head;
a single actuator (motor) may be used for producing the combined translational and clearing movement of the scraper.

1-17. (canceled)

18. A continuous jet printer comprising:
a printing head; and
a device for cleaning the operating head upon stopping ejection of printing liquid, wherein the printing head comprises
a generator of one or more printing liquid jets comprising a plate provided with at least one nozzle for ejecting printing liquid along a direction Y;
a sorting block to selectively deviate the liquid emitted by the at least on enozzles of the generator, and disposed adjacent to the nozzle plate while being shifted relative to the ejection direction Y of the at least one nozzle; and
a gutter for recovering portions of printing liquid ejected from the at least one nozzle and not for printing, the gutter being disposed adjacent to the sorting block; and
wherein the cleaning device comprises
a flexible scraper with a profile mating a profile delimited by the nozzle plate at least at the at least one nozzles, by the sorting block and by the recovery end of the gutter;
means for displacing the flexible scraper along at least a direction X transverse to the printing liquid ejection direction Y, a displacement of the flexible scraper being such that a deformed profile of the flexible scraper conforms with and rubs on a mating profile delimited by the nozzle plate at least at the at least one nozzle, by the sorting block, and by a recovery end of the gutter;
means for feeding cleaning liquid over a height H of the profile of the flexible scraper along the ejection direction Y simultaneously with its transverse displacement; and
means for drawing up cleaning liquid which contains particles wiped by the flexible scraper, over the height H of the profile of the flexible scraper along the ejection direction Y simultaneously with its transverse displacement, the feeding and suction means being adapted for confining the cleaning liquid between its feed and its suction over the height H and in proximity to the flexible scraper profile deformed by transverse displacement of the flexible scraper.

19. The continuous jet printer according to claim 18,
wherein the flexible scraper comprises an elastomeric part comprising at least two cuts on a thickness of the flexible scraper, three segments delimited by the cuts each respectively bearing upon a surface delimited by the nozzle plate at least at the at least one ejection nozzle, by the sorting block and by the recovery end of the gutter.

20. The continuous jet printer according to claim 18,
wherein the flexible scraper is inserted between two rigid flanges attached to the flexible scraper by protruding in a plane YZ transverse to the displacement direction X to form a scraper module,
wherein the cleaning liquid feeding means comprises at least one channel made in the flexible scraper or in one of the two attached flanges to bring the cleaning liquid onto the height H of the flexible scraper, and
wherein the cleaning liquid suction means comprises at least one channel contained in one of the two attached flanges to draw up the cleaning liquid which contains particles wiped by the flexible scraper, over the height H of the flexible scraper, the scraper module being laid out during a cleaning operation of the cleaning device and during a printing operation of the head at the same time, so as to not protrude underneath the recovery gutter, the underside of the flexible scraper being defined relative to a printing liquid ejection direction oriented vertically downwards.

21. The continuous jet printer according to claim 20,
wherein a total width of the scraper module 1 along the transverse displacement direction X is such that the flexible scraper is positioned facing a non-functional area of the sorting block during the printing operation of the head and upon stopping of the cleaning.

22. The continuous jet printer according to claim 20,
wherein the flexible scraper is inserted between both flanges to assume an ajar position with at least one of both flanges, and
wherein the cleaning liquid feeding and suction channels open out on the face of said at least one ajar flange with the flexible scraper facing the at least one ajar flange, a displacement of the scraper module along the direction X transverse to the printing liquid ejection direction Y causing the flexible scraper to rub against the nozzle plate, the sorting block, and the recovery end of the gutter in its ajar position, to allow the cleaning liquid to be brought by the feeding channel of the at least one ajar flange and the cleaning liquid to be sucked up through the suction channel of the at least one ajar flange.

23. The continuous jet printer according to claim 22,
wherein one of said flanges protrudes relative to the other one of said flanges to achieve an ajar condition between the elastomeric part and said protruding flange.

24. The continuous jet printer according to claim 22,
wherein several cleaning liquid feeding channels are included on the face of the at least one flange and are uniformly distributed over the height H, and
wherein the suction channels are disposed at a periphery of the liquid feeding channels according to a profile which is homothetic to the profile delimited by the nozzle plate at least at the at least one ejection nozzle, by the sorting block, and by the recovery end of the gutter.

25. The continuous jet printer according to claim 20,
wherein the cleaning liquid feeding means comprises the nozzle plate, at least one channel contained in a thickness of the flexible scraper to bring the cleaning liquid onto the height H of the flexible scraper via one or more jets of cleaning liquid ejected from the nozzle plate, and
wherein the cleaning liquid suction means comprises at least one channel contained in a thickness of at least one said flange to draw up the cleaning liquid which contains particles wiped by the flexible scraper over its height.

26. The continuous jet printer according to claim 25,
wherein the cleaning liquid feeding means comprises at least one solenoid valve to eject the cleaning liquid jets of the nozzle plate intermittently.

27. The continuous jet printer according to claim 25,
wherein the suction means comprises a suction point underneath the flexible scraper being defined relative to a direction of ejection of the printed liquid, and oriented vertically downwards.

28. The continuous jet printer according to claim 25,
wherein the suction channel is connected to a source of depressurized air, and a cleaning liquid feed pressure is adapted to air depressurization during the cleaning operation to confine the cleaning liquid which contains particles wiped on the height H of the flexible scraper.

29. The continuous jet printer according to claim 18,
wherein the means for displacing the flexible scraper comprises a slide on which a component may slide, the flexible scraper being firmly attached to the sliding component, and
wherein a length of the slide is such that the transverse displacement travel of the scraper (C) is larger than the largest width (L) along the translational direction of the flexible scraper, selected from a width of the nozzle plate, of the sorting block, and of the gutter, to position the flexible scraper at an end of the slide during the printing operation of the head and upon stopping of the cleaning.

30. The continuous jet printer according to claim 18,
wherein a cleaning cycle consists of one or more reciprocal movements of the flexible scraper along the transverse direction.

31. The continuous jet printer according to claim 18,
wherein a cleaning cycle comprises one or more reciprocal movements along the transverse direction and one or more approach and withdrawal movements of the flexible scraper by spacing apart, at the same time, the scraper from the nozzle plate, from the sorting block, and from the recovery gutter.

32. The continuous jet printer according to claim 31,
wherein the displacement means are further adapted for displacing the scraper in a plane YZ orthogonal to the translational displacement to place the scraper away from the nozzle plate, from the sorting block, and from the recovery gutter at the same time.

33. The continuous jet printer according to claim 18,
wherein the sorting block has facing the one or more printing liquid jets a planar face or conformed with one or more bevels in a plane (YZ) orthogonal to the displacement of the flexible scraper along the X direction.

34. The continuous jet printer according to claim 18,
wherein the sorting block comprises a device having at least one electrode exerting an electrostatic action on jets of liquid.
